(19) United States
(12) Patent Application Publication
(10) Pub. No.: US 2002/0060063 A1
(43) Pub. Date: May 23, 2002

(54) Process for producing an accumulator composite for accumulating heat or cold

(75) Inventors: Mark Neuschutz, Darmstadt (DE); Marlies Niemann, Buttelborn (DE)

Correspondence Address: MILLEN, WHITE, ZELANO & BRANIGAN, P.C., 2200 CLARENDON BLVD., SUITE 1400, ARLINGTON, VA, 22201, US

(73) Assignee: Merck GmbH, Darmstadt (DE)

(21) Appl. No.: 09/855,016

(22) Filed: May 15, 2001

(30) Foreign Application Priority Data
May 15, 2000 (DE) 100 23 572.7

(51) Int. Cl. F25B 29/00; C09K 3/18

(52) U.S. Cl. 165/61; 252/70

(57) ABSTRACT

The invention relates to a process for producing an accumulator composite comprising evacuating an impregnation vessel after partially or completely immersing a matrix in a phase change material in the impregnation vessel.

The present invention relates to a process for producing an accumulator composite for accumulating heat or cold in the form of phase change heat from a matrix of compressed, expanded graphite and phase change material (PCM) which is introduced into this matrix, by vacuum impregnation of the matrix with the PCM.

The accumulation of thermal energy, both in the form of heat and of cold, is of considerable general interest in many respects. First of all, efficient accumulation technology allows energy supply and demand to be temporally and locally decoupled, and secondly more efficient utilization of periodically available energy sources, for example of solar energy, becomes possible. This results in considerable advantages in particular with a view to environmental protection and economic viability. One technique for the accumulation of heat or cold is based on the utilization of phase transitions with a heat tone which is based either on the change in the state of aggregation or a chemical reaction. In most cases, the solid/liquid phase transition is utilized for energy purposes by means of PCM (phase change material). One example of an important phase change material is water for accumulating cold. However, it is also possible to use other phase transitions, for example solid/gas or liquid/gas.

However, most known techniques for the accumulation of thermal energy entail one or more of the following technical difficulties which need to be overcome: a change in volume during the phase transition, supercooling, low thermal conductivity, separation of the components, complex heat exchange processes and temperature control.

DE 196 30 073 A1 describes an accumulator composite for accumulating heat or cold and the way in which it is produced. The composite consists of an inert graphite matrix with a bulk density of more than 75 g/l which has been impregnated in vacuo with a solid/liquid phase change material (PCM). The graphite matrix has a high porosity and allows a high PCM loading of up to at most 90% by volume without it being destroyed by a change in volume during the phase transition. A high PCM loading in the accumulator composite is important because in this way it is possible to achieve a high energy density. One advantage of this solution is the use of graphite as matrix material, which by its nature has a high thermal conductivity and, since it is substantially chemically inert, imposes scarcely any restrictions on the PCM.

However, the accumulator composite which is described in DE 196 30 073 A1 has a number of drawbacks which are relevant to its production process (vacuum impregnation). The process is characterized in that prior to the impregnation the matrix, which has been produced from compressed, expanded graphite, is heated, at a pressure of less than 10 mbar, to a temperature which is preferably between 10 and 40 Kelvin above the melting point, but at most up to the evaporation temperature of the PCM. As a result of a valve leading to the PCM vessel being opened, the molten PCM, which is then present in excess, is sucked into the graphite matrix. Then, the accumulator composite is preferably cooled to below room temperature, in order to reduce the escape of PCM gases until the storage container is closed. The use of two separate vessels for the graphite matrix and the PCM makes the outlay on equipment and operation very high, including with regard to temperature and pressure control.

Accordingly, one feature of the invention is to provide an improved process for the vacuum impregnation of a compressed, expanded graphite matrix with a solid/liquid phase change material (PCM), so as to produce an accumulator composite of high elasticity/stability, with a high thermal conductivity, a high energy density as a result of a high PCM loading and which is complementary to a large number of PCMs, and the execution of which is greatly simplified compared to the prior art and therefore is also considerably less expensive.

According to the invention, this feature may be achieved by the process for vacuum impregnation. Advantageous and preferred embodiments of the subject matter of the application are given in the subclaims.

One embodiment of the invention is therefore a process for producing an accumulator composite for accumulating heat or cold from a matrix of compressed, expanded graphite and phase change material (PCM) which is introduced into this matrix, by vacuum impregnation of the matrix with the PCM, which is characterized in that the matrix, under atmospheric pressure and partially or completely immersed in a molten PCM, is fixed inside an impregnation vessel, and the impregnation vessel is then evacuated until the desired degree of loading of the matrix with the PCM has been achieved.

The impregnation vessel is preferably evacuated to a pressure which corresponds to the vapor pressure of the molten PCM.

It has been found that the size of the impregnation vessel is preferably selected in such a way that its remaining gas space after filling approximately corresponds to the volume of the molten PCM.

Surprisingly, it has been established that the process according to the invention of vacuum impregnation of a graphite matrix with PCM using only one vessel, namely the impregnation vessel, i.e. with direct contact between the PCM and the matrix prior to evacuation, does not entail any drawbacks with respect to the product quality of the resultant accumulator composites, for example as a result of inhibited or impaired degassing of the porous graphite matrix, and in addition the complexity of the equipment is significantly simplified. There is no need for the PCM to be heated in an external vessel, i.e. there is no need for separate temperature control, but rather the equipment in its entirety, which is usually in the form of a desiccator, is exposed to a heat source, for example a drying cabinet. This also eliminates the complex regulation of the metering in combination with the pressure regulation (evacuation) by means of various valves. According to the invention, the impregnation vessel is preferably evacuated to a pressure until the boiling point of the molten PCM is reached and is then closed by means of a valve. Consequently, it is unnecessary to cool the accumulator composite to room temperature, as described in the prior art, in order to reduce the escape of PCM gases until the storage container is closed. The only control which according to the invention may have to be carried out when using hydrated salts as PCM relates to the previous metering of a corresponding amount of water, which compensates for the loss of water caused by evaporation when using a very large gas space.

The vacuum impregnation process according to the invention can be continued until the residual porosity of the accumulator composite is approximately 5% by volume. This residual porosity can be reached after an impregnation period of up to approximately five days, preferably of approximately up to four days. The graphite matrix expediently has a density of about 75 to about 1500 g/l, preferably about 75 to about 300 g/l, particularly preferably approximately of about 200 g/l.

The process according to the invention results in accumulator composites which are distinguished by a high PCM loading and therefore by a high energy density, a high elasticity or stability and by a high thermal conductivity. The excellent stability despite the high loading (residual porosity only about 5% by volume), as a result of the density of > about 75 g/l of the graphite matrix, is made manifest by a high matrix tolerance with respect to expansion of the PCM in the pores, which expresses itself as a high elasticity of the accumulator composite. This high elasticity has the associated advantage that the expansion of the PCM (for example water/ice 8%) can be absorbed completely internally by the composite, so that there is no need for complex control technology in order to protect the composite from being destroyed as a result of expansion.

The process according to the invention preferably comprises the use of a PCM which undergoes a solid/liquid phase transition in the temperature range from about −25° C. to about 150° C. Water represents a preferred PCM.

Other PCMs which can be used in the process according to the invention are the following components or eutectic or congruently melting mixtures of at least two of the components selected from CaBR₂, CaCl₂.6H₂O, CaCl₂, KF, KCl, KF.4H₂O, LiClO₃.3H₂O, MgSO₄, MgCl₂, ZnCl₂.2.5H₂O, ZnSO₄, Ba(OH)₂, H₂O, SO₃.2H₂O, NaCl, NaF, NaOH, NaOH.3.5H₂O, Na₂HPO₄, Na₂SO₄, Na₂SO₄.10H₂O, NH₄Cl, NH₄H₂PO₄, NH₄HCO₃, NH₄NO₃, NH₄F, (NH₄)₂SO₄, Al (NO₃)₂, Ca(NO₃)₂, Cd(NO₃)₂, KNO₃, LiNO₃, Mg(NO₃)₂, Mg(NO₃).6H₂O, NaNO₃, Ni(NO₃)₂, Zn(NO₃)₂, Zn(NO₃)₂.6H₂O, Cu(NO₃)₂, acetic acid, acetates. A eutectic mixture of LiNO₃ and Mg(NO₃)₂.6H₂O is preferably used as the PCM.

If hydrated salts are used as the PCM, the molten PCM, with regard to the anhydrous salt, in a certain way represents a solution of the salt in its water of hydration.

Without further elaboration, it is believed that one skilled in the art can, using the preceding description, utilize the present invention to its fullest extent. The following preferred specific embodiments are, therefore, to be construed as merely illustrative, and not limitative of the remainder of the disclosure in any way whatsoever.

In the foregoing and in the following examples, all temperatures are set forth uncorrected in degrees Celsius; and, unless otherwise indicated, all parts and percentages are by weight.

The entire disclosure of all applications, patents and publications, cited herein, and corresponding German Application No. DE 100 23572.7, filed May 15, 2000, is hereby incorporated by reference.

### EXAMPLE

### Impregnation of the Graphite Matrix

In a vacuum desiccator in the drying cabinet, the expanded, compressed graphite matrix with a bulk density of 0.2 g/ml (3 liters, 0.6 kg) in the form of plates with dimensions of 12×12×1 cm was completely immersed in approximately 6 kg of PCM, which consisted of a eutectic mixture of LiNO₃/Mg(NO₃)₂.6H₂O (density 1.6 g/ml, 3.8 liters of molten material). The temperature wag raised to 90° C. and the pressure in the vacuum desiccator was slowly reduced until the boiling point of the PCM was reached. Until the boiling point of the PCM was reached after about 5 minutes, only gas emerged from the matrix. The desiccator valve was closed in order to avoid a loss of water during the impregnation operation. After an impregnation period of three to four days, a PCM loading of the graphite matrix of 85% was found, which with a 10% graphite volume corresponds to a residual porosity of 5% by volume.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. A process for producing an accumulator composite for accumulating heat or cold from a matrix of compressed, expanded graphite and a phase change material introduced into this matrix, by vacuum impregnation of the matrix with the phase change material, comprising partially or completely immersing a matrix in a molten phase change material, fixed inside an impregnation vessel under atmospheric pressure, and then evacuating the impregnation vessel to obtain the desired degree of matrix loading.

2. A process according to claim 1, comprising evacuating the impregnation vessel to a pressure corresponding to the vapor pressure of the molten phase change material.

3. A process according to claim 1, wherein the impregnation vessel has a remaining gas space after filling approximately corresponding to the volume of introduced molten phase change material.

4. A process according to claim 1, further comprising continuing the vacuum impregnation until the residual porosity of the accumulator composite is approximately 5% by volume.

5. A process according to claim 1, wherein the vacuum impregnation is carried out over a period of up to approximately five days.

6. A process according to claim 1, wherein the phase change material undergoes a solid/liquid phase transition in the temperature range of about −25° C.- about 150° C.

7. A process according to claim 1, wherein the phase change material is water.

8. A process according to claim 1, wherein the phase change material is at least one of the following components or a mixture thereof:
CaBR₂, CaCl₂.6H₂O, CaCl₂, KF, KCl, KF.4H₂O, LiClO₃.3H₂O, MgSO₄, MgCl₂, ZnCl₂2.5H₂O, ZnSO₄, Ba(OH)₂, H₂O, SO₃.2H₂O, NaCl, NaF, NaOH, NaOH.3.5H₂O, Na₂HPO₄, Na₂SO₄, Na₂SO₄.10H₂O, NH₄Cl, NH₄H₂PO₄, NH₄HCO₃, NH₄NO₃, NH₄F, (NH₄)₂SO₄, Al(NO₃)₂, Ca(NO₃)₂, Cd(NO₃)₂, KNO₃, LiNO₃, Mg(NO₃)₂, Mg(NO₃).6H₂O, NaNO₃, Ni(NO₃)₂, Zn(NO₃)₂, Zn(NO₃)₂.6H₂O, Cu(NO₃)₂, acetic acid, or an acetate.

9. A process according to claim 1, wherein the phase change material is a eutectic mixture of LiNO₃ and Mg(NO₃)₂.6H₂O.

10. A process according to claim 1, wherein the matrix has a density of about 75- about 1500 g/l.

11. A process according to claim 8 wherein the phase change material is a eutectic mixture of at least two of the components.

12. A process according to claim 8, wherein the phase change material is a congruently melting mixture of at least two of the components.

13. A process according to claim 1, wherein the matrix has a density of about 75- about 300 g/l.

14. A process according to claim 1, wherein the matrix has a density of 75-1500 g/l.

15. A process for producing an accumulator composite comprising evacuating an impregnation vessel after partially or completely immersing a matrix in a phase change material in the impregnation vessel.

16. A process for producing an accumulator composite comprising heating a matrix partially or completely immersed in a phase change material.

17. An accumulator composite comprising graphite wherein the accumulator composite comprises a phase change material loading of at least about 85%.
